(19) United States
(12) Patent Application Publication
(10) Pub. No.: US 2016/0207076 A1
(43) Pub. Date: Jul. 21, 2016

(54) APPARATUS AND METHOD FOR REMOVING ABRASIVE PARTICLES FROM WITHIN A PANEL

(71) Applicant: Ikonics Corporation, Duluth, MN (US)

(72) Inventors: Karl Wagner, Duluth, MN (US); Troy Bergstedt, Esko, MN (US)

(21) Appl. No.: 15/002,034

(22) Filed: Jan. 20, 2016

Related U.S. Application Data
(60) Provisional application No. 62/105,412, filed on Jan. 20, 2015.

(51) Int. Cl. B08B 5/02; B08B 1/00; B08B 5/04

(52) U.S. Cl. CPC B08B 5/02; B08B 5/04; B08B 1/002

(57) ABSTRACT

An apparatus and method for removing abrasive particles from within a panel is disclosed. More specifically, an apparatus and method for removing abrasive particles from within a panel with compressed air and a vacuum is disclosed.

This application claims the benefit of U.S. Provisional Application No. 62/105,412, filed Jan. 20, 2015, the contents of which are herein incorporated by reference.

### FIELD OF THE TECHNOLOGY

The present application relates to an apparatus and method for removing abrasive particles from within a panel, such as a sound-insulation panel.

### SUMMARY OF THE INVENTION

A method of removing particles from an object having multiple partially enclosed cavities is described, the method can include providing an object having an interior and a top surface, the interior comprising a plurality of separated volumes, and the top surface comprising a plurality of openings, wherein at least some of the volumes contain at least two openings in the top surface, and wherein at least some of the volumes include particles within the volumes; and simultaneously applying a stream of compressed air and a vacuum to portions of the top surface of the object, wherein the stream of compressed air is directed to a first portion of the top surface and the vacuum is delivered to a second portion of the top surface, such that the compressed air and vacuum are applied to different openings in the top surface to the same volume within the object at the same time; wherein the application of compressed air and vacuum cause at least some of the particles within the volumes to be removed.

A nozzle for removing particulate contaminants from a panel containing partially closed spaces is also disclosed, the nozzle can comprise a first opening, the first opening being configured for connection to a pressurized air source; a second opening, the second opening being configured for connection to a vacuum source; wherein the first opening and second opening are configured such that when placed in contact with a surface containing a plurality of holes, the first opening covers a first hole in the surface and the second opening covers a second hole in the surface.

### BRIEF DESCRIPTION OF THE FIGURES

The technology may be more completely understood in connection with the following drawings, in which:

FIG. 1 is a perspective view of a nozzle for removing particles from within a panel or other object, according to an embodiment.

FIG. 2 is a perspective view of a nozzle for removing particles from within a panel or other object, according to an embodiment.

FIG. 3 is a cross-section view of a nozzle for removing particles from within a panel or other object, according to an embodiment.

FIG. 4 is a cross-section view of a nozzle showing the air knife, according to an embodiment.

FIG. 5 is a cross-section view of a panel and nozzle, according to an embodiment.

FIG. 6 is a cross-section view of a panel and nozzle, according to an embodiment.

FIG. 7 is a cross-section view of a panel and nozzle, according to an embodiment.

FIG. 8 is a cross-section view of a panel and nozzle, according to an embodiment.

FIG. 9 is a cross-section view of a panel and nozzle, according to an embodiment.

FIG. 10 is a cross-section view of a panel and nozzle, according to an embodiment.

FIG. 11 is a cross-section view of a panel and nozzle, according to an embodiment.

FIG. 12 is a cross-section view of a panel and nozzle, according to an embodiment.

FIG. 13 is a cross-section view of a panel and nozzle, according to an embodiment.

FIG. 14 is a flow cart depicting a method for removing abrasive particles from within a panel, according to an embodiment.

FIG. 15A is a horizontal cross-section view of a nozzle, according to an embodiment, showing multiple nozzle segments joined to produce a wider total nozzle surface.

FIG. 15B is a horizontal cross-section view of a nozzle, according to an embodiment, showing multiple nozzle segments joined to produce a wider total nozzle surface.

FIG. 15C is a horizontal cross-section view of a nozzle, according to an embodiment, showing multiple nozzle segments joined to produce a wider total nozzle surface.

FIG. 15D is a horizontal cross-section view of a nozzle, according to an embodiment, showing multiple nozzle segments joined to produce a wider total nozzle surface.

FIG. 15E is a is a horizontal cross-section view of a nozzle, according to an embodiment, showing multiple nozzle segments joined to produce a wider total nozzle surface.

FIG. 16A is a horizontal cross-section view of a nozzle, according to an embodiment, configured for joining together to produce a single wider nozzle surface.

FIG. 16B is a horizontal cross-section view of a composite nozzle, according to an embodiment, showing individual sections joined together to produce a single wider nozzle surface.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The present application relates to an apparatus and method for removing abrasive particles from within a panel or other object. More specifically, the present application relates to an apparatus and method for removing abrasive particles from within a panel or other object with an air knife and a vacuum. The apparatus and method can be used to remove abrasive particles from various panels and objects, such as sound deadening panels, which include a top surface and a bottom surface. Such panels are often constructed with a corrugated or honeycomb element disposed between two surfaces, and can have increased stiffness or strength with a marginal increase in weight relative to a panel without a corrugated or honeycomb element. The corrugated or honeycomb element can be disposed between the top surface and the bottom surface. The corrugated or honeycomb element can define a plurality of volumes, sometimes called flutes, with the volumes extending perpendicular from the top surface and the bottom surface.

During processing the top or bottom surface can be partially covered by a mask. Abrasive particles are projected at the top or bottom surface to wear away or ablate the portions of the top surface that are not covered by the mask, thereby creating a plurality of holes in the top surface. In various embodiments, some of the abrasive particles are retained within the volumes after creating a hole. Using the current apparatus and method, abrasive particles are removed from the volumes, such as to provide a panel that is substantially free of abrasive particles, or at least has the number of particles significantly reduced. This reduction in particles within the panels can lead to significant reductions in the weight of the panels, which is particularly relevant to applications where the panel weight is very important, such as aerospace applications. In addition, the removal of the particles from the panels prevents their gradual release over time after installation, thereby avoiding a source of dirt and contamination.

In certain aspects a method of removing particles from an object having multiple partially enclosed cavities is provided, the method comprising providing an object having an interior and a top surface, the interior comprising a plurality of separated volumes, and the top surface comprising a plurality of openings, wherein at least some of the volumes contain at least two openings in the top surface, and wherein at least some of the volumes include particles within the volumes; and simultaneously applying a stream of compressed air and a vacuum to portions of the top surface of the object, wherein the stream of compressed air is directed to a first portion of the top surface and the vacuum is delivered to a second portion of the top surface, such that the compressed air and vacuum are applied to different openings in the top surface to the same volume within the object at the same time; wherein the application of compressed air and vacuum cause at least some of the particles within the volumes to be removed.

In some implementations the compressed air is delivered by way of an air knife.

In some implementations the stream of compressed air and a vacuum are supplied by a nozzle, the nozzle containing a central compressed air source and a peripheral vacuum source. Optionally the openings in the top surface of the object comprise less than twenty five percent of the surface area of the top surface, alternatively the openings in the top surface of the object comprise less than ten percent of the surface area of the top surface, or in some embodiments the openings in the top surface of the object comprise less than five percent of the surface area of the top surface.

In some modes of operation the nozzle simultaneously applies the stream of compressed air and vacuum to portions of the top surface of the object, the nozzle comprising a first opening, the first opening being configured for communication with a pressurized air source; and a second opening, the second opening being configured for communication with a vacuum source. The first opening is positioned within the second opening in some implementations, and optionally the second opening surrounds the first opening. In certain implementations first opening is less than 50 percent the area of the second opening.

The first opening generally has a length and a width, and optionally the length being at least twice the width. The second opening has a length and a width, the length optionally being at least twice the width. In some implementations the first and second openings each have a length and a width, and the length of the first opening is less than or equal to 90 percent of the length of the second opening, or 95 or 99 percent of the length of the second opening in some configurations. Alternatively the first and second openings each have a length and a width, and the length of the first opening is substantially equal to the length of the second opening.

Also disclosed is a nozzle for removing particulate contaminants from a panel containing partially closed spaces, the nozzle comprising: a first opening, the first opening being configured for communication with a pressurized air source; a second opening, the second opening being configured for communication with a vacuum source; wherein the first opening and second opening are configured such that when placed in contact with a surface containing a plurality of holes, the first opening covers a first hole in the surface and the second opening covers a second hole in the surface. Optionally the first opening is positioned within the second opening; and optionally the second opening surrounds the first opening. In some implementations the nozzle includes a flexible end so as to conform to a curved or planar surface.

The first opening is less than 50 percent the area of the second opening in some embodiments, less than 40 percent, less than 20 percent, less than 15 percent, less than 10 percent, or less than 5 percent of the area of the second opening in some constructions. The second opening can comprise a flexible end, the flexible end selected from an elastomeric material, a flexible material, or a brush material.

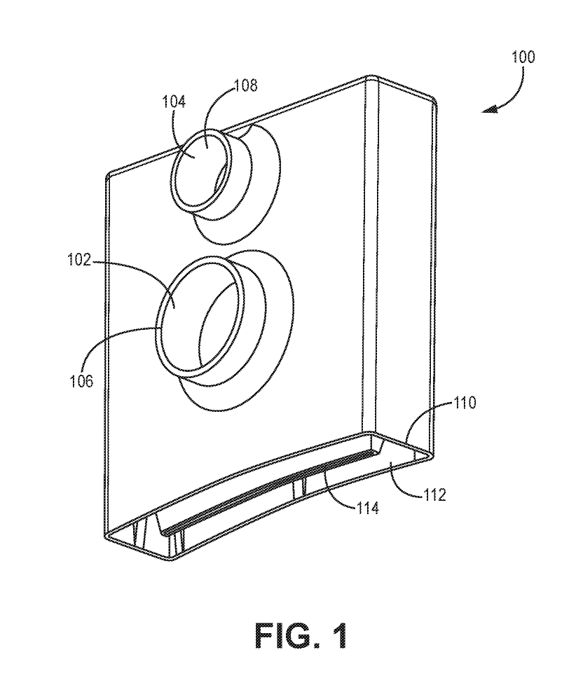

Now, in reference to the drawings, FIG. 1 shows a front perspective view of a nozzle 100 according to an embodiment of the invention. The nozzle 100 can comprise a vacuum portion 102 and an air knife portion 104. The vacuum portion 102 can be configured to suck or remove abrasive particles from the inside of a panel. The air knife 104 is configured to direct a stream of pressurized air through a hole in the surface of a panel. The stream of air can disrupt the particles in the volume, such as loosening the particles. The stream of air can causes a positive pressure in the volume, such as to aid in the removal of the abrasive particles by the vacuum portion 102.

In various embodiments, the vacuum portion 102 includes a vacuum port 106. The vacuum port 106 is configured to couple a vacuum line, tube, or pipe to the nozzle 100. In various embodiments, the air knife portion 104 can include an air line port 108. The air line port 108 can be configured to couple a pressurized air line, tube, or pipe to the nozzle 100.

The nozzle 10 can include a panel engaging surface 110, such as on the bottom of the nozzle. The panel engaging surface 110 refers to the surface closest to the panel while the nozzle is removing abrasive particles from the panel. In some embodiments, the panel engaging surface 110 is curved, such as to match a curved surface of the panel. In various embodiments, the panel engaging surface 110 can be flexible, such as to conform to the surface of the panel. The depicted example panel engaging surface 110 includes a vacuum inlet 112 and an air knife outlet 114. The vacuum inlet 112 includes inlet of airflow through the vacuum portion 102. The air knife outlet 114 includes the outlet of airflow through air knife portion 104.

In some embodiments, the surface area of the vacuum inlet 112 is two times the surface area of the air knife outlet 114. The surface area of the vacuum inlet 112 can be three times the surface area of the air knife outlet 114 in some embodiments. The surface area of the vacuum inlet 112 can be four times the surface area of the air knife outlet 114 in other embodiments, and five times the surface area of the air knife outlet 114 in other embodiments. Optionally the surface area of the vacuum inlet 112 can be ten times the surface area of the air knife outlet 114. In various embodiments, the air knife outlet 114 is located within the vacuum inlet 112, such as the vacuum inlet 112 can surround the air knife outlet 114. The air knife outlet 114 can be rectangular and the vacuum inlet 112 can be rectangular.

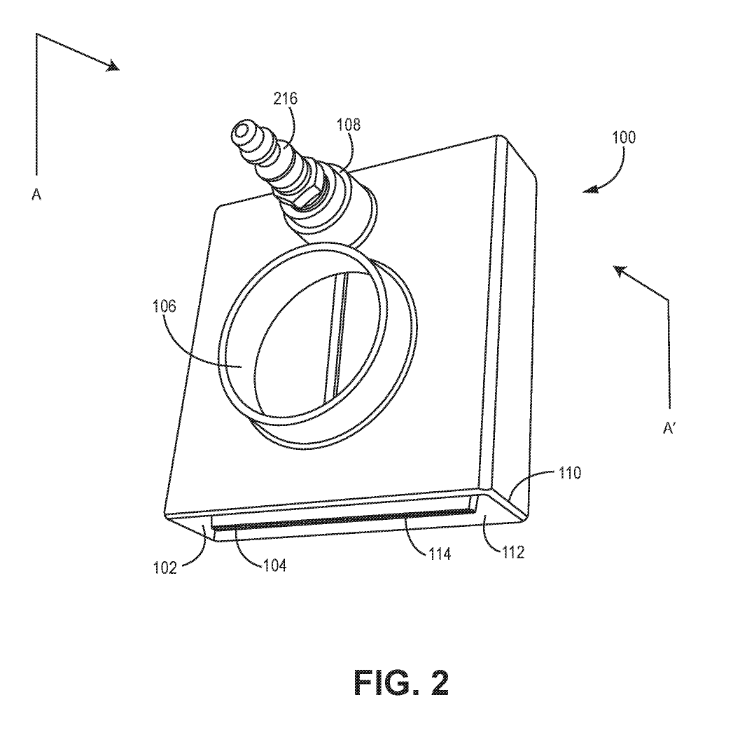

FIG. 2 shows a further perspective view of a nozzle 100, according to an embodiment. In various embodiments, a connector 216 can be coupled to the air line port 108. The panel engaging surface 110 can be flat or planar. The panel engaging surface 110 can include a flexible member coupled to the bottom surface of the nozzle 100. The panel engaging surface 110 can be surface normal, such as the panel engaging surface 110 is normal to the surface with holes in it. In example implementations the flexible member can conform to the surface that the flexible member is positioned against, such as to create a seal whether the surface is flat or curved. The flexible member can include, for example, a rubber or a polymer. Alternatively, the flexible member may comprise a brush-type seal with bristles that flex and conform to surface curves or irregularities.

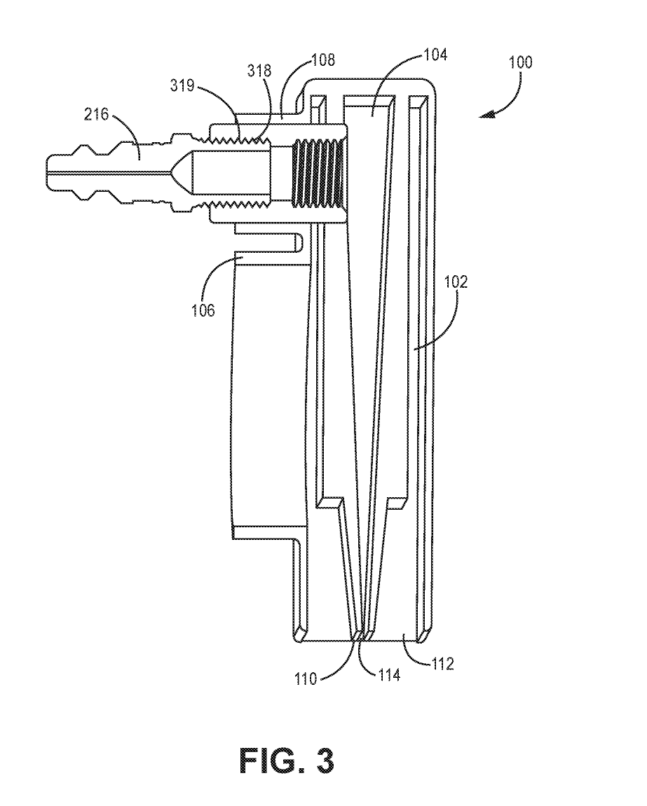

FIG. 3 shows a cross-section view of a nozzle 100, according to an embodiment, taken along plane A-A′ of FIG. 2. The air knife portion 104 or plenum chamber can include two converging or non-parallel surfaces, such as to focus the air flow. In an embodiment, the air flow can be laminar. The two converging or non-parallel surfaces can define a boundary between the air knife portion 104 and the vacuum portion 102. The vacuum portion 102 extends, in the depicted embodiment, around the perimeter of the panel engaging surface 110. The connecter 216 can include threads 318, the air line port 108 can include threads 319, such as to mate with threads 318 on the connector 216. In various embodiments, the air line port 108 and the vacuum port 106 are perpendicular to the flow of air at the panel engaging surface 110.

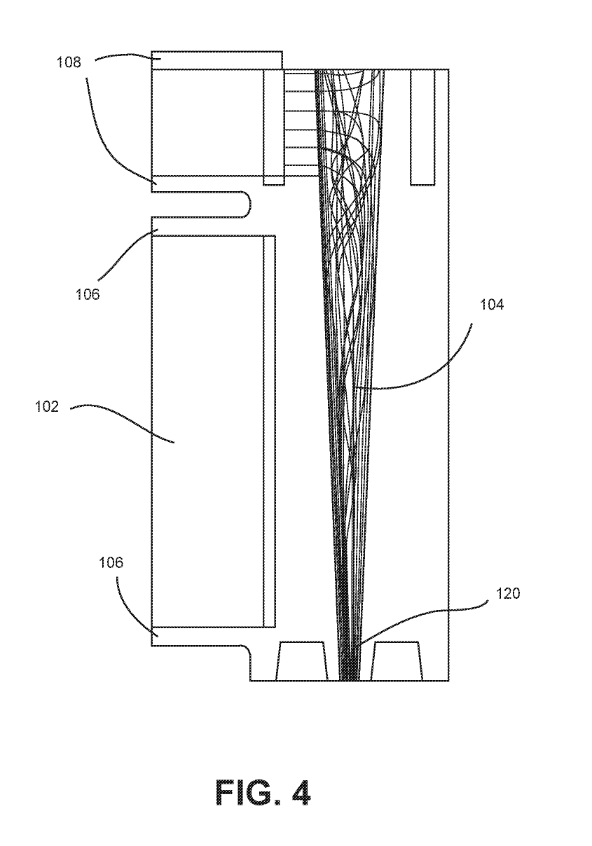

FIG. 4 shows a simplified cross-section view of a nozzle showing the air knife 104, according to an embodiment, the cross section taken along plane A-A′ of FIG. 2, the same as the cross section shown in FIG. 3. FIG. 4 shows a representation of potential paths of the air takes in travelling through the air knife 104. In various embodiments, the two converging or non-parallel surfaces direct air entering the air knife portion 104 to a more focused, smaller area 120. The focusing of the air to a smaller cross-section 120 can focus the stream of air into one or more holes in a panel. In some embodiments, the air knife 104 can contact the surface having holes. There can be a momentary drop in pressure and increase in velocity as the air moves from the air knife 104 to the internal volume or volumes of the panel. The volumes can become pressurized to the same pressure as the air knife 104, such that when the air exits the volume the velocity of the air will increase but the pressure will decrease. Air that comes in from the air line port 108 can be deflected by the two converging surfaces, until the air exits the nozzle 100 through the air knife outlet 114.

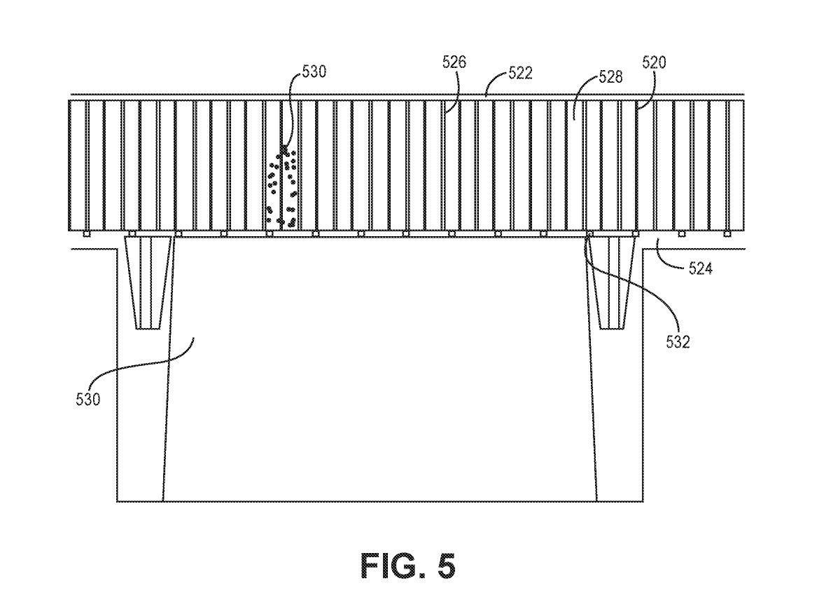

FIG. 5 shows a cross-section view of a panel with simulated air flow paths, such as that shown in FIG. 4. The panel 520 includes a top surface 522 and a bottom surface 524. The panel 520 further includes a corrugated or honeycomb element 526. The corrugated or honeycomb element 526 is disposed between the top surface 522 and the bottom surface 524. The corrugated or honeycomb element 526 can define a plurality of volumes 528, such as channels that extend from the bottom surface 524 to the top surface 522. The volumes 528 can be perpendicular to the top surface 522 or the bottom surface 524.

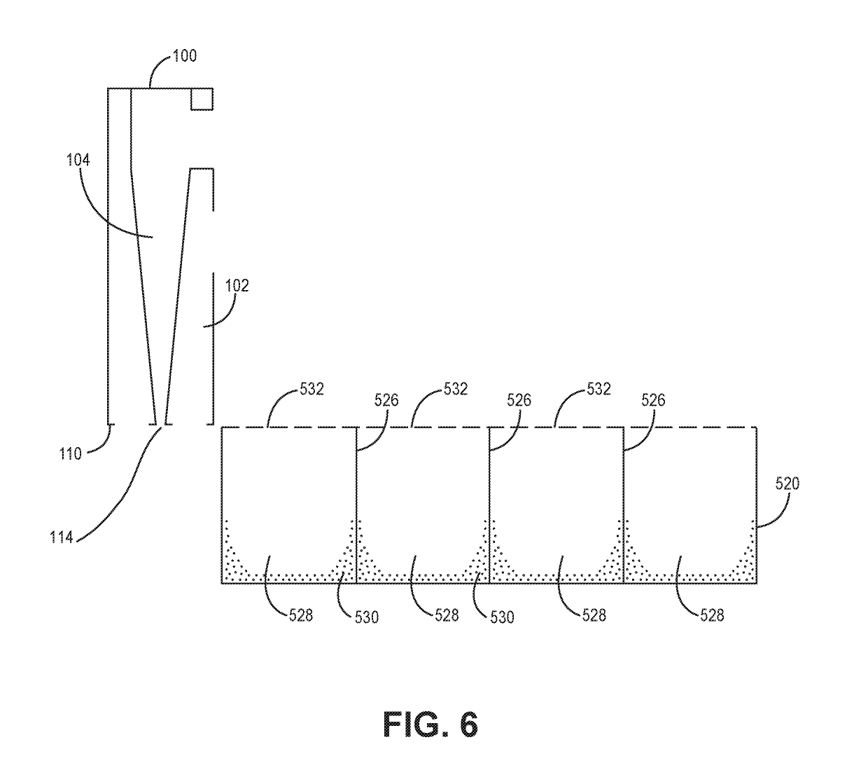

FIG. 6 shows a cross-section view of a panel 520 and nozzle 100, according to an embodiment. The embodiment shown in FIG. 6, shows all of the volumes with abrasive particles 530 in them. In some embodiments it will be understood that not all of the volumes have abrasive particles 530 within them. The nozzle 100 is constructed to pass over the surface with the holes 532 while removing the abrasive particles 530 from the volumes. In various embodiments the air knife outlet 114 is sized to be substantially the same width as a diameter of holes 532 in the panel 520, but in other implementations the outlet 114 is sized to be larger than the holes 532 in the panel 520. At various times the air knife outlet does not overlap with an adjacent hole in the same volume 528. The width of the nozzle 100 can have a substantially similar size as a volume 528, such that the remaining uncovered portion of volume 528 that the air knife outlet 114 is positioned over can be covered by the vacuum inlet 112. In various embodiments, the volumes 528 can be at least 0.25 inches wide and not more than 2 inches wide. In alternative embodiments, the volumes 528 can be at least 0.375 inches wide and not more than 1 inch wide.

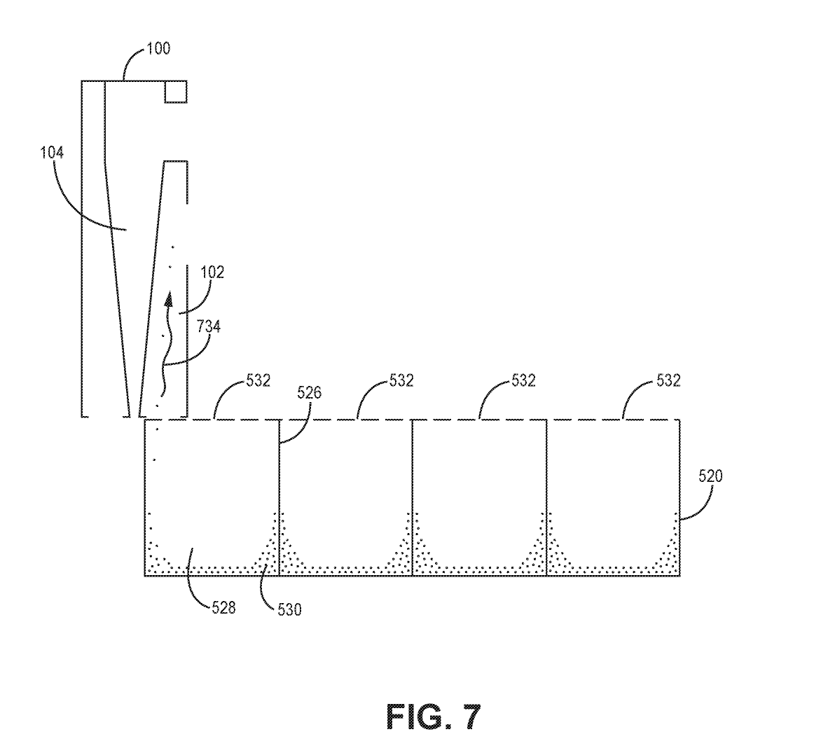

FIG. 7 shows a cross-section view of a panel 520 and nozzle 100, as the nozzle 100 moves across the panel 520. The abrasive particles 530 are sucked up by the vacuum portion 102. Arrow 734 shows the direction of air moving through the nozzle 100, specifically the vacuum portion 102. As shown in FIG. 7, the particles are removed through holes 532, although some of the abrasive particles 530 can be unaffected by the vacuum portion 102.

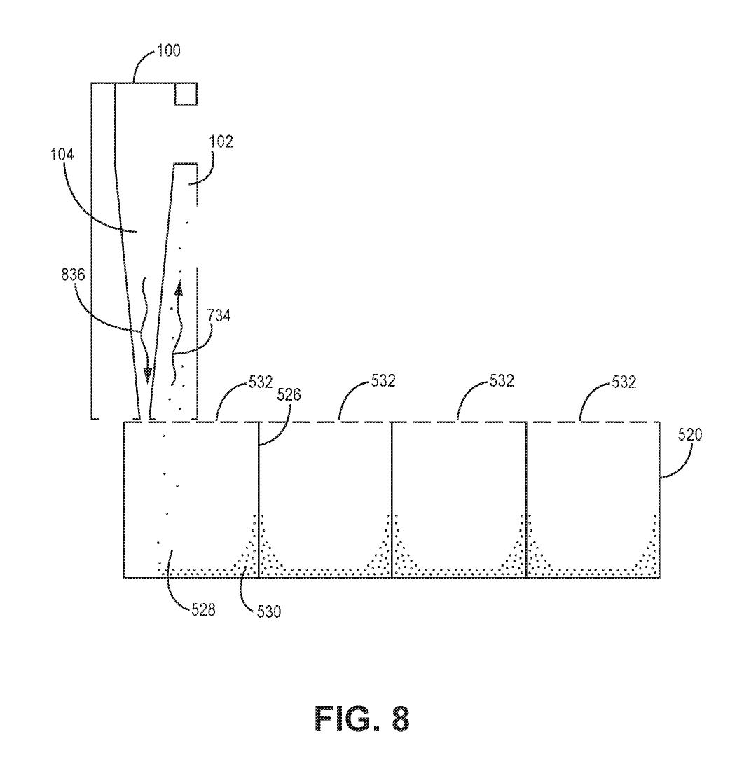

FIG. 8 shows a cross-section view of a panel and nozzle 100, according to an embodiment, as the nozzle 100 continue to move across panel 520. Arrow 836 shows the direction of air moving through the air knife portion 104 of the nozzle 100. The air from the air knife portion 104 can loosen or separate any abrasive particles that have settled in the volume. The vacuum portion 102 can remove the abrasive particles 530 that the air knife 104 separates from the volume.

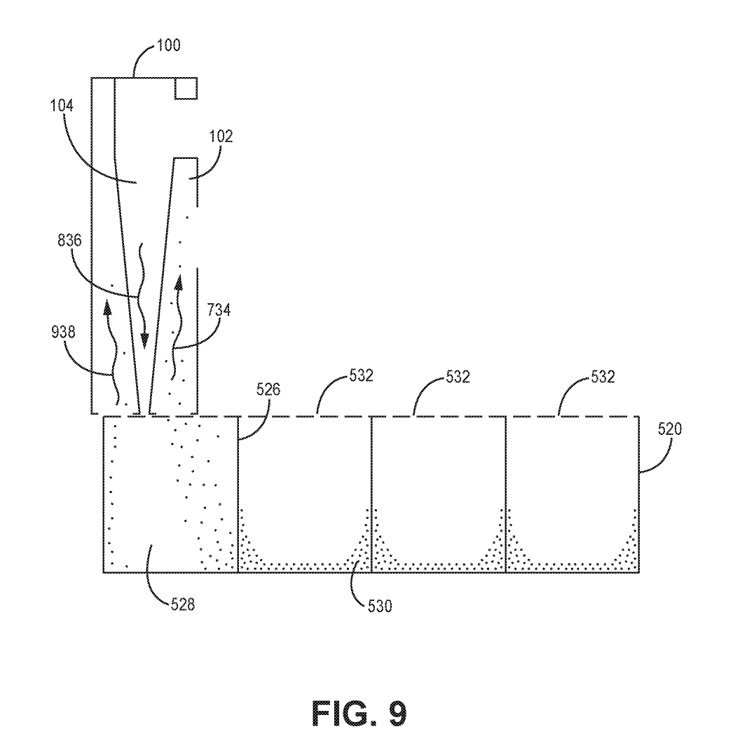

FIG. 9 shows a cross-section view of a panel 520 and nozzle 100, with the nozzle 100 even further along the panel 520. The nozzle 100 continues to pass over the holes 532 in panel 520. The second part of the vacuum portion 102 is located over a hole 532 that the first part of the vacuum portion 102 and the air knife portion 104 have already passed over. Arrow 938 shows the direction of the air moving through the second part of the vacuum portion of the nozzle 100. The second part of the vacuum portion 102 can remove any remaining abrasive particles from the volume.

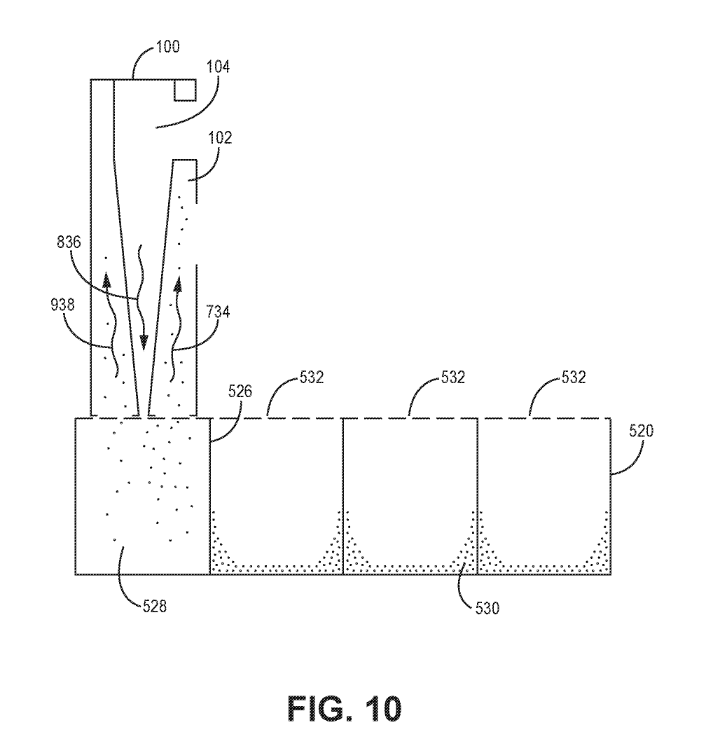

FIG. 10 shows a cross-section view of a panel 520 and nozzle 100, with the nozzle 520 further along the surface of panel 520. Volume 528 can has a width larger than the nozzle 100, such that the nozzle 100 is substantially located over a single volume 528. In alternative embodiments, the nozzle 100 can be larger than a volume 528, such that the nozzle 100 can be removing abrasive particles 530 from multiple adjacent volumes simultaneously. FIG. 10 shows a nozzle removing abrasive particles 530 from the volume 528 with both the first part of the vacuum portion 102 (arrow 734) and the second part of the vacuum portion 102 (arrow 938) while the air knife portion 104 loosens abrasive particles 530 in the volume 528.

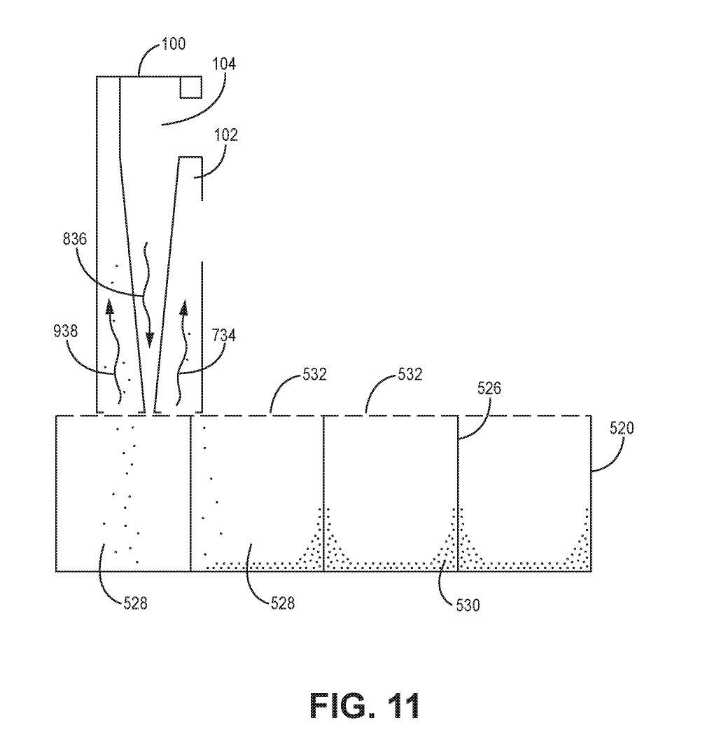

FIG. 11 shows a cross-section view of a panel 520 and nozzle 100. FIG. 11 shows the first part of the vacuum portion 102 removing abrasive particles 530 from a volume 528′, while the air knife portion 104 and second part of the vacuum portion 102 remove abrasive particles from volume 528. As discussed above, the air knife portion 104 can loosen abrasive particles 530 and create a positive pressure within the volume 528 to aid the vacuum portion 102 in removing the abrasive particles 530 from the volume 528.

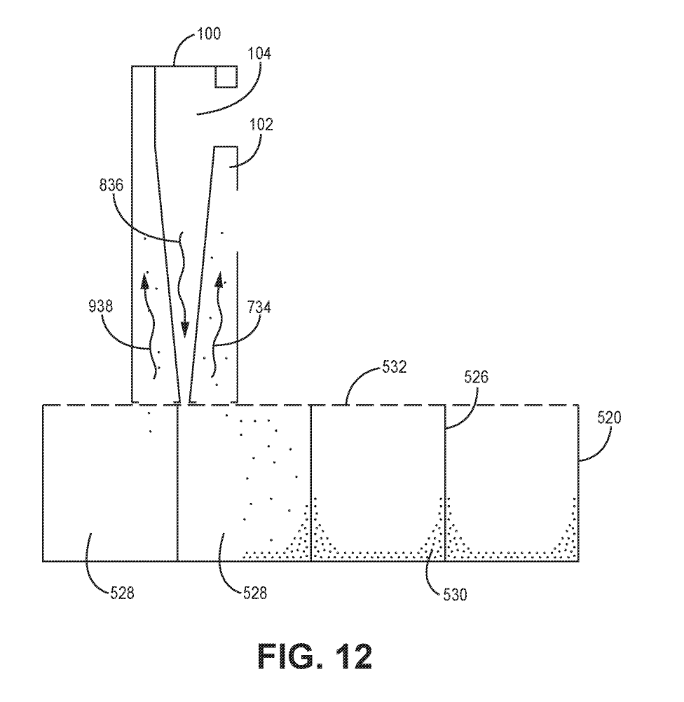

FIG. 12 shows a cross-section view of a panel 520 and nozzle 100, according to an embodiment. The second part of the vacuum portion 102 (arrow 938) can remove any remaining abrasive particles from volume 528. The first part of the vacuum portion 102 (arrow 734) and the air knife portion 104 are removing and agitating abrasive particles in volume 528′, similar to volume 528 in FIG. 8.

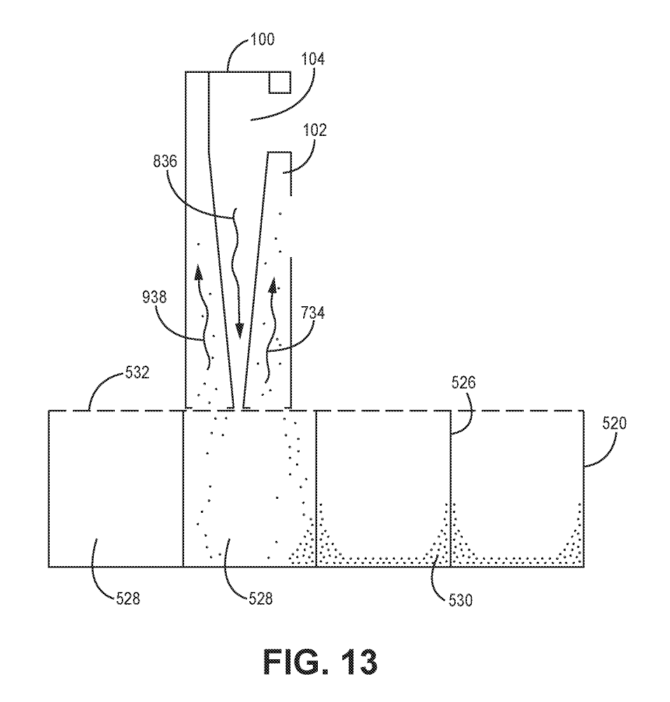

FIG. 13 shows a cross-section view of a panel 520 and nozzle 100, according to an embodiment. FIG. 13 shows a nozzle removing abrasive particles 530 from the volume 528′ with both the first part of the vacuum portion 102 (arrow 734) and the second part of the vacuum portion 102 (arrow 938) while the air knife portion 104 loosens abrasive particles 530 in the volume 528′. Volume 528 can be substantially free from abrasive particles 530.

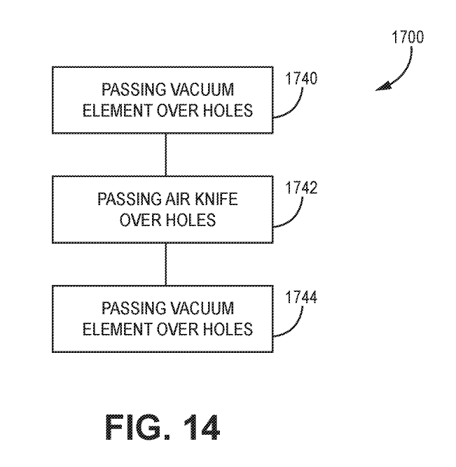

FIG. 14 is a flow cart depicting a method 1700 for removing abrasive particles from within a panel, according to an embodiment. The method 1700 can include passing a vacuum element over a plurality of holes, step 1740. Step 1742 can include passing an air knife element over the plurality of holes. Step 1744 can include passing a vacuum element over the plurality of holes.

The method 1700 can further include creating the plurality of holes with abrasive particles. At least some of the abrasive particles can be retained within the panel.

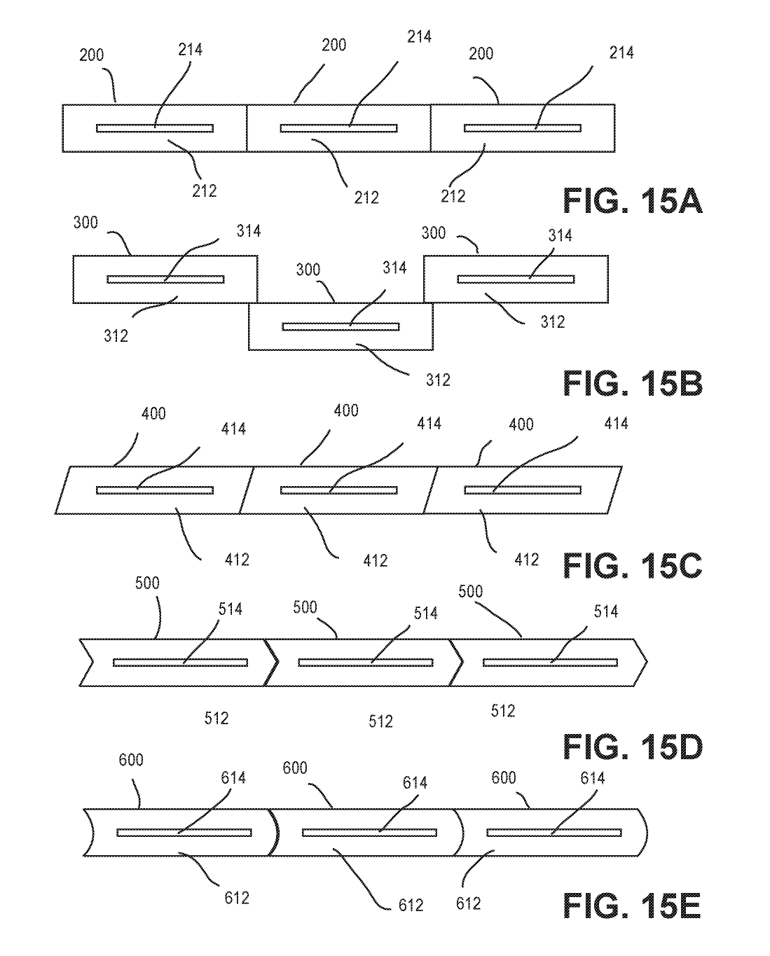

FIG. 15A is a horizontal cross-section view of a composite nozzle, according to an embodiment, showing multiple nozzle segments joined to produce a wider total nozzle surface. The composite nozzle includes individual nozzles 200, each with a vacuum portion 212 and an air knife portion 214. The composite nozzle is shown with three individual nozzles 200, but it will be understood that there can be more or fewer nozzles 200, such as two, four, five, six, or more. The composite nozzle allows for a wider and larger panel or object to be treated at one time.

FIG. 15B is a horizontal cross-section view of a composite nozzle, according to an embodiment, showing multiple nozzle segments joined to produce a wider total nozzle surface. The composite nozzle includes individual nozzles 300, each with a vacuum portion 312 and an air knife portion 314. In the depicted embodiment, the nozzles 300 are offset from one another, which provides a slight overlap so that when the nozzles are moved across a surface no portion is missed. The composite nozzle is shown with three individual nozzles 300, but it will be understood that there can be more or fewer nozzles 300, such as two, four, five, six, or more. The composite nozzle allows for a wider and larger panel or object to be treated at one time.

FIG. 15C is a horizontal cross-section view of a composite nozzle, according to an embodiment, showing multiple nozzle segments joined to produce a wider total nozzle surface. The composite nozzle includes individual nozzles 400, each with a vacuum portion 412 and an air knife portion 414. In the depicted configuration, each of the nozzles 400 has angled edges to form a parallelogram (in cross section), again allowing for an overlap so that when nozzles are moved across a surface no portion is missed. The composite nozzle is shown with three individual nozzles 400, but it will be understood that there can be more or fewer nozzles 400, such as two, four, five, six, or more.

FIG. 15D is a horizontal cross-section view of a composite nozzle, according to an embodiment, showing multiple nozzle segments joined to produce a wider total nozzle surface. The composite nozzle includes individual nozzles 500, each with a vacuum portion 512 and an air knife portion 514. In the depicted configuration, each of the nozzles 500 has angled edges to form concave and concave edges (in cross section), again allowing for an overlap so that when nozzles are moved across a surface no portion is missed. The composite nozzle is shown with three individual nozzles 500, but it will be understood that there can be more or fewer nozzles 500, such as two, four, five, six, or more.

FIG. 15E is a horizontal cross-section view of a composite nozzle, according to an embodiment, showing multiple nozzle segments joined to produce a wider total nozzle surface. The composite nozzle includes individual nozzles 600, each with a vacuum portion 612 and an air knife portion 614. In the depicted configuration, each of the nozzles 600 has curved edges to form concave and concave edges (in cross section), again allowing for an overlap so that when nozzles are moved across a surface no portion is missed. The composite nozzle is shown with three individual nozzles 600, but it will be understood that there can be more or fewer nozzles 600, such as two, four, five, six, or more.

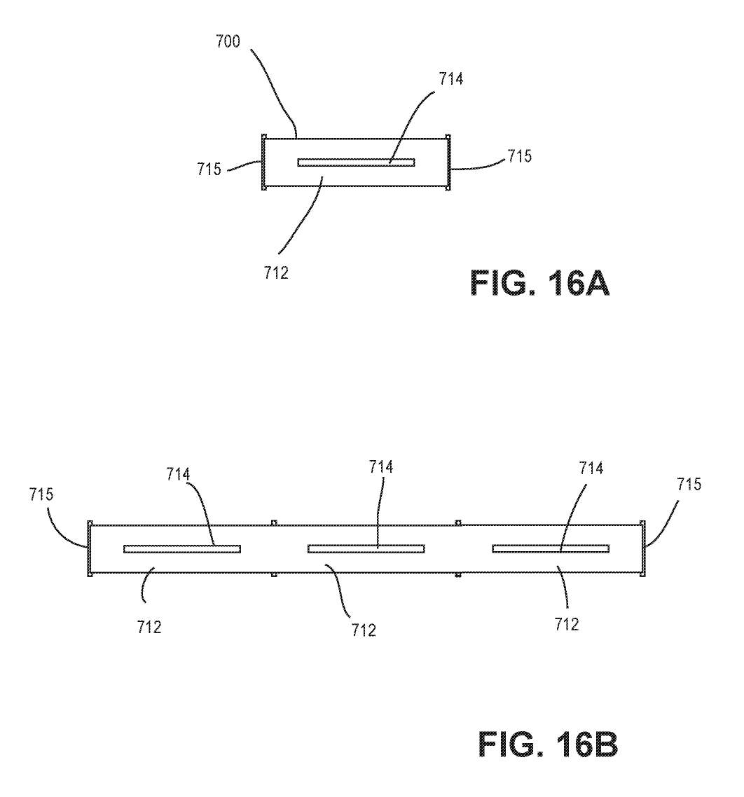

FIG. 16A is a horizontal cross-section view of a nozzle, according to an embodiment, configured for joining together to produce a single wider nozzle surface. The nozzle 700, each with a vacuum portion 712 and an air knife portion 714, along with removable ends 715. As shown in FIG. 16B, the removable ends 715 can be removed, allowing adjacent nozzles to be connected to form a single large nozzle (but with the ends 715 retained on the two sides of the composite nozzle. The composite nozzle is shown with three individual nozzles, but it will be understood that there can be more or fewer nozzles, such as two, four, five, six, or more.

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the invention.

We claim:

1. A method of removing particles from an object having multiple partially enclosed cavities, the method comprising:
providing an object having an interior and a top surface, the interior comprising a plurality of separated volumes, and the top surface comprising a plurality of openings, wherein at least some of the volumes contain at least two openings in the top surface, and wherein at least some of the volumes include particles within the volumes; and
simultaneously applying a stream of compressed air and a vacuum to portions of the top surface of the object, wherein the stream of compressed air is directed to a first portion of the top surface and the vacuum is delivered to a second portion of the top surface, such that the compressed air and vacuum are applied to different openings in the top surface to the same volume within the object at the same time;
wherein the application of compressed air and vacuum cause at least some of the particles within the volumes to be removed.

2. The method of claim 1, wherein compressed air is delivered by way of an air knife.

3. The method of claim 1, wherein simultaneously applying of a stream of compressed air and a vacuum are supplied by a nozzle, the nozzle containing a central compressed air source and a peripheral vacuum source.

4. The method of claim 1, wherein the openings in the top surface of the object comprise less than twenty five percent of the surface area of the top surface.

5. The method of claim 1, wherein the openings in the top surface of the object comprise less than five percent of the surface area of the top surface.

6. The method of claim 1, wherein a nozzle simultaneously applies the stream of compressed air and vacuum to portions of the top surface of the object, the nozzle comprising a first opening, the first opening being configured for communication with a pressurized air source; and a second opening, the second opening being configured for communication with a vacuum source.

7. The method of claim 6, wherein the first opening is positioned within the second opening.

8. The method of claim 6, wherein the second opening surrounds the first opening.

9. The method of claim 8, wherein the first opening is less than 50 percent the area of the second opening.

10. The method of claim 6, wherein the first opening has a length and a width, the length being at least twice the width.

11. The method of claim 6, wherein the second opening has a length and a width, the length being at least twice the width.

12. The method of claim 6, wherein the first and second openings each have a length and a width, and the length of the first opening is less than or equal to 90 percent of the length of the second opening.

13. The method of claim 6, wherein the first and second openings each have a length and a width, and the length of the first opening is substantially equal to the length of the second opening.

14. A nozzle for removing particulate contaminants from a panel containing partially closed spaces, the nozzle comprising:
a first opening, the first opening being configured for communication with a pressurized air source;
a second opening, the second opening being configured for communication with a vacuum source;
wherein the first opening and second opening are configured such that when placed in contact with a surface containing a plurality of holes, the first opening covers a first hole in the surface and the second opening covers a second hole in the surface.

15. The nozzle of claim 15, wherein the first opening is positioned within the second opening.

16. The nozzle of claim 15, wherein the second opening surrounds the first opening.

17. The nozzle of claim 15, comprising a flexible end so as to conform to a curved or planar surface.

18. The nozzle of claim 15, wherein the first opening is less than 50 percent the area of the second opening.

19. The nozzle of claim 15, wherein second opening comprises a flexible end, the flexible end selected from an elastomeric material, a flexible material, or a brush material.
